(19) United States
(12) Patent Application Publication
(10) Pub. No.: US 2004/0263885 A1
(43) Pub. Date: Dec. 30, 2004

(54) Interlacing methods for lenticular images

(76) Inventor: John Tomczyk, Shoreview, MN (US)

Correspondence Address: Merchant & Gould P.C., P. O. Box 2903, Minneapolis, MN, 55402-0903, US

(21) Appl. No.: 10/850,470

(22) Filed: May 20, 2004

Related U.S. Application Data
(60) Provisional application No. 60/472,166, filed on May 20, 2003.

(51) Int. Cl. H04N 1/52; H04N 1/56; H04N 1/393; H04N 1/387

(52) U.S. Cl. 358/1.9; 358/530; 358/536; 358/1.2; 358/1.18; 358/540

(57) ABSTRACT

The present disclosure provides a computer-implemented digital prepress method of interlacing images, including: providing a set of at least two graphic images to a computer; raster image processing the digital representations for each image to provide a set of screened color-separated digital files that correspond with each graphic image; interlacing the screened color-separated digital files of like color for the graphic images to produce one interlaced file for each color; optionally saving the interlaced files as digital files for each color; and outputting the interlaced digital files to a digital output device. The present disclosure also provides a lenticular product having lenticulated images prepared by the above method.

### CROSS REFERENCE TO RELATED APPLICATIONS

This application claims priority to provisional application No. 60/472,166, filed May 20, 2003, entitled “INTERLACING METHODS FOR LENTICULAR IMAGES.”

### BACKGROUND OF THE INVENTION

Interlacing is the process of combining data from at least two images (or “graphics”) into a format compatible with a lenticular lens array. Lenticular printing and interlacing have been practiced for many years.

When digital prepress equipment is used, typically the interlacing of the image files is performed before imposition, which is the process of arranging duplicates of the set of images onto a larger sheet for greater throughput during manufacture. Next, the imposed data is processed by a raster image processor (RIP), or “ripped,” along with applying the proper screening to produce rasterized files in each of a set of individual colors (e.g., the additive process color set of red, green, and blue; or, most preferably, the common subtractive print process color set of cyan, magenta, yellow, and black). Conventional half-toning is an example of a process that employs screening.

After the “ripping” step, printing plates for each of the colors are made, and the lenticular image is printed onto an appropriate substrate in a conventional printing process. The lenticular lens material is added unless it formed the substrate (i.e., the printing was directly to the lenticular material).

Additional details of the conventional processes are disclosed in U.S. Pat. No. 5,924,870 (Brosh, et al.); U.S. Pat. No. 6,091,482 (Carter, et al.); and published U.S. patent application No. 20030016370 (Goggins). The entire disclosure of each of these documents is incorporated by reference into this application for purposes of providing background on the general nature of lenticular images, the interlacing methods conventionally used to produce lenticular images, and terminology understood in the art.

### BRIEF DESCRIPTION OF THE DRAWINGS

The accompanying drawings show a particular embodiment of the disclosure as an example, and are not intended to limit the scope of the disclosure.

FIGS. 1 and 2 are schematic representations of the method in embodiments of the disclosure.

FIG. 3 is a schematic cross-section of a portion of a lenticular product manufactured in accordance with the disclosure.

FIG. 4 is a schematic diagram illustrating principles associated with embodiments of the disclosure.

FIGS. 5A and 5B are schematic diagrams comparing, by way of illustration, a conventional process and embodiments of the disclosed process, respectively.

FIG. 6 is a workflow diagram illustrating a conventional process.

FIG. 7 is a workflow diagram illustrating embodiments of the disclosure.

### DETAILED DESCRIPTION OF THE PREFERRED EMBODIMENT

The disclosure concerns methods of using digital prepress equipment, specifically interlacing to form lenticular images, and products incorporating the lenticular images formed according to those methods.

Definitions “Raster image processor” refers to a combination of computer software and hardware that controls the printing process by calculating the bit maps of images and instructing printing device to create the images. See also Pocket Pal, A Graphic Arts Production Handbook, edited by M. Bruno, International Paper Co., 17th Ed. (1997) p 109-110.

“Consisting essentially of” in embodiments can refer to the components or steps listed in the claim, plus other components or steps that do not materially affect the basic and novel properties of the method of use or making, such as the particular form of input images selected, a particular software package selected for accomplishing a recited operation, and like considerations.

The indefinite article “a” or “an” and its corresponding definite article “the” as used herein is understood to mean at least one, or one or more, unless specified otherwise.

The disclosure addresses a problem in the conventional lenticular printing process described above. In some circumstances, especially when the lenticular image contains many fine details, the interlaced image stripes produced by the interlacing step are very narrow in width. When the screening process coincides on the pixels of the stripes, a so-called “average dot” is created. This prevents the boundaries between the individual phases from being clearly demarked straight lines, which in turn degrades the quality of the lenticular image.

The disclosure solves this problem by interlacing after the screening step. This enables the screened dots to be divided into straight lines, particularly when using a preferred digital output device, employing for example a laser, whose output dimensions and scan profile are selected to create rectilinear (preferably square) spots in the manufacture of the printing plates. A preferred implementation of this option is described in U.S. Pat. No. 6,121,996 (Gelbart) and is marketed by Creo Incorporated under the trade name SQUAREspot®. However, the scope of the disclosure includes other techniques of achieving the same or equivalent result.

In conventional processes, all interlacing occurs before screening. Typically, digital images (made up of pixels) are processed by a RIP program and/or a screening program. The RIP converts the files to each of the set of desired colors. The screening process produces, at phase transition lines, averaged pixels that are required by the screening program as dictated by the front-end RIP system. This is because the screening program needs to form non-rectangular (typically approximately round) dots from rectangular (typically square) pixels; and the dots must be larger at transitions between phases, which requires that the dots be averaged together, giving rise to possible phase transition anomalies.

Thus, in embodiments of the disclosure image pixels can be efficiently converted to image dots having, for example, vertical straight line transitions and without aliasing (“jaggies”) and thereby enhancing optical effects, such as less ghosting, and smooth transitions between phases.

In embodiments of the disclosure, the method permits creation of a workflow in which any modification to the effective resolution of the printed image does not require repeating the entire prepress process.

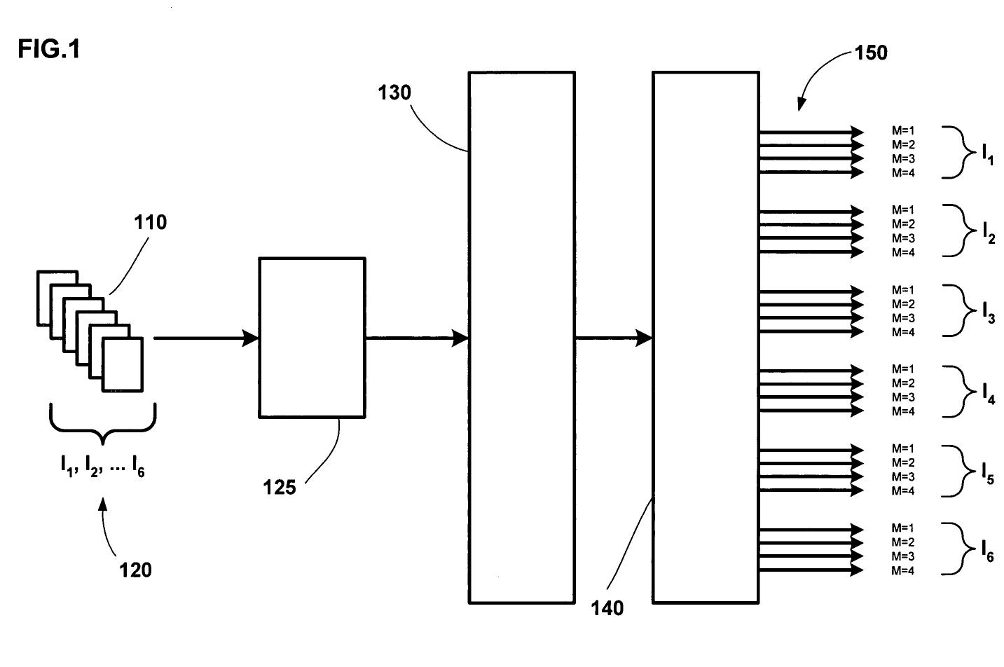

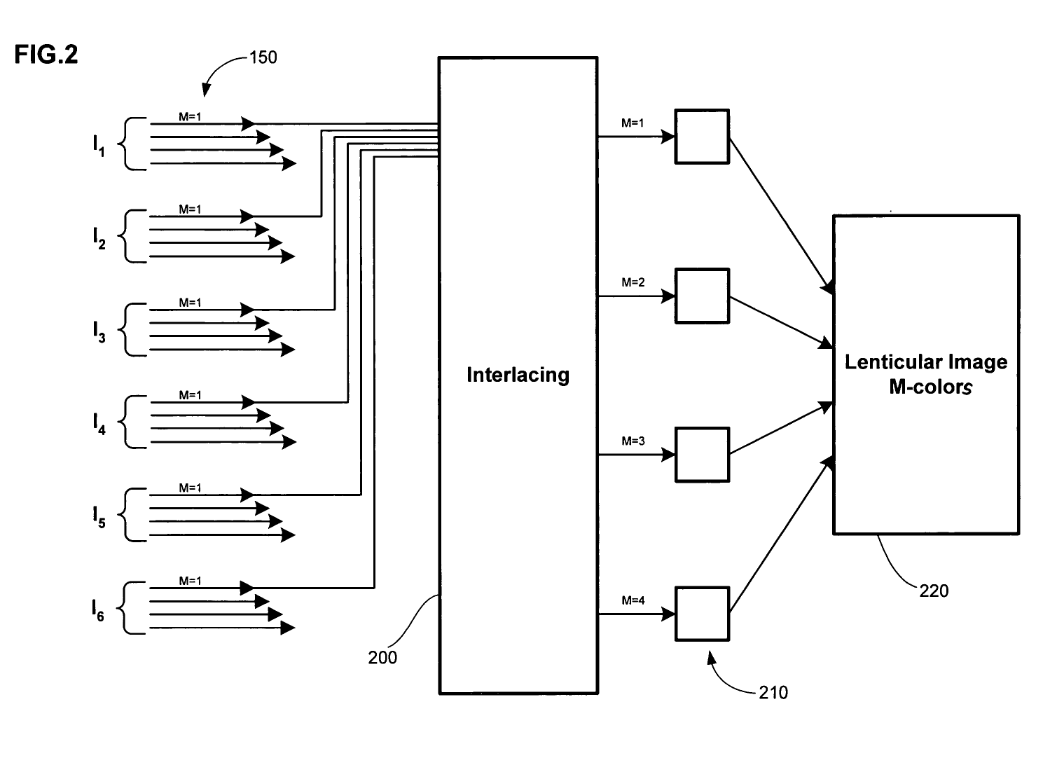

FIGS. 1 and 2 are schematic representations of the disclosure. By way of example only, in FIG. 1, six input images are illustrative of the more general case of a set of N images 110, such as at least two or more, designated I₁, I₂ . . . I_{N}. An optional imposition program 125 in FIG. 1 can be used but is not required in further processing of the images of the disclosed processes. In embodiments, the imposition program can optionally be applied at later stages of the method of the disclosure if desired, such as before outputting to a digital output device. Each output of the imposition program (or each of the set of I_{N} images, if the imposition program is not used) is first rasterized with raster image processing 130 and then screened 140 by an appropriate screening program (which may operate on the set of N images in serial or in parallel) to produce a set of N output files 150. Each output file comprises sub-files corresponding to each of the M colors 120 employed in the process. In the example process illustrated in FIGS. 1 and 2, a four color process is shown and thus M=1, 2, 3, and 4. A number of imposition programs are commercially available and are readily adapted to the imposing operation, see for example, Citation Software Inc., Nashua, N.H. (www.citationsoftware.com), which provides a variety of different imposition solutions and features for various runtime environments and file formats.

Referring to FIG. 2, the output files 150 can then be re-grouped so that all of the individual color phases corresponding to a single one of the M colors are interlaced 200 together. For purposes of clarity only, FIG. 2 shows this in detail only for M=1 for each I_{N}, but it is understood that interlacing is performed for each of the M colors. This produces a set of M interlaced files 210 that are then separately outputted to an output device to form a composite lenticular image 220 suitable for use in a digital output printing method. The digital output device can be, for example, a direct-to-plate (DTP) output device, a film recorder, an ink jet printer, a film setter, a digital printing press, a direct-to-screen output device, and like devices, or equivalents or combinations thereof. If the digital output device is a DTP output device, it is preferred that the plates generated by the DTP output device are for use on a printing press. The printing press may employ any of the printing methods known in the art, including for example and without limitation, sheet fed offset, web flexography, web offset methods, and like methods, or combinations thereof.

One preferred use of the printed lenticular image is in the manufacture of a printed lenticular sheet, such as that formed by mounting the printed lenticular sheet to a lenticular lens in any suitable manner. Acceptable types of lenticular lenses are those having the configurations of, for example, fisheye, spherical lens having a flat top, triangular, elliptical, and like geometries, or combinations thereof.

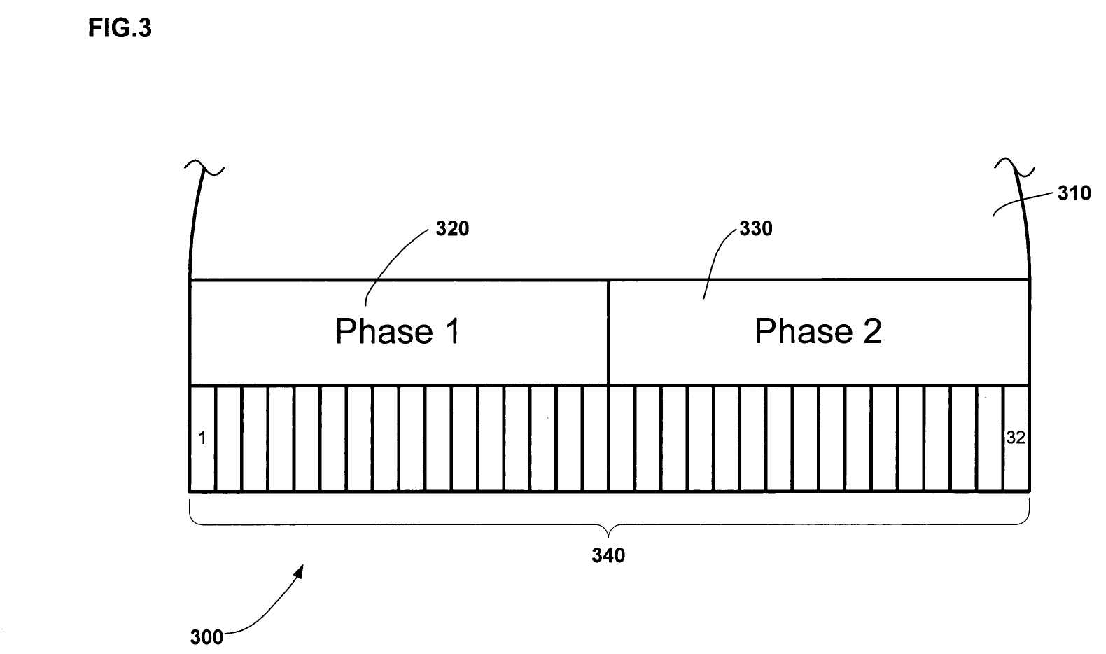

Accordingly, FIG. 3 illustrates a portion 300 of a lenticular material manufactured according to the principles of the disclosure, in which a single lenticular lens 310 is illustrated in a broken or disconnected manner to emphasize that the disclosure is not limited to the particular cross-sectional shape of lenticule 310. As an example, those portions of the image beneath lens 310 are indicated as being a “two-phase” or “flip” arrangement, i.e., a pair of images corresponding to two different views of the lenticular product, i.e., phase 1 (320) and phase 2 (330). This is only an example, as three or more phases are within the scope of the disclosure. The entire set of phases 340, in this instance phase 1 (320) and phase 2 (330), are comprised of 32 interlaced stripes successively numbered 1 to 32 in FIG. 3. The disclosure is not limited to these values, however. It is readily understood that the set of phases 340 can be repeated for each and every lenticule lens 310 associated with the lenticulated image.

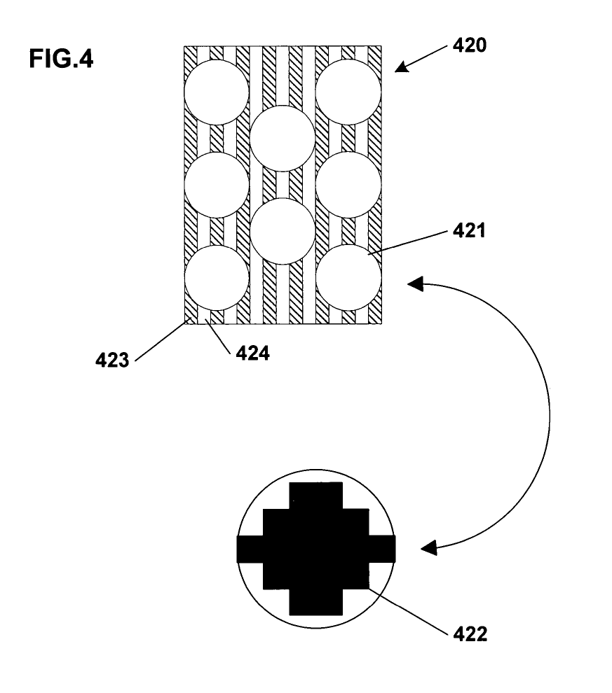

Referring to FIG. 4, to form printed halftone interlaced images of each phase 420 (e.g., phase 1 of FIG. 3) it is necessary to form screen dots 421 from pixels widths 423 and 424 (repeating) according to conventional processes. The vertical rectangles represent pixel widths 423 and 424 and run parallel to the eventual lens direction. In the example shown about 5 pixels (423 and 424) get averaged into a screen cell. It is understood that “halftone” applies to each of the individual colors. As illustrated in FIG. 4, each dot 421 is formed from averaged pixel tonal values 422 that approximate or correspond in width to the underlying pixel widths 423 and 424. Each dot 421 also has a height that is equal in distance to the pixel width but the height is not specifically indicated in FIG. 4 for purposes of clarity.

It is common, as illustrated above, for the resolution of the output device (measured in pixels or dots per linear unit, e.g., dots per inch or DPI) not to be an integral multiple of the pitch of the lenticular material (measured in lenticules per linear unit, e.g., lenticules per inch or LPI). For example, in typical commercial embodiments, lenticule 310 is approximately (1/75.45), or approximately 0.01325381 inches wide in the plane of FIG. 3. Thus, each stripe is approximately (1/2414.4) inches wide, i.e., approximately 2,400 stripes per inch. While 2,400 stripes per inch is evenly dividable by 75 lenticules per inch to produce exactly 32 stripes per lenticule (as illustrated in FIG. 3), if an output device having resolution of 2,400 DPI is used with lenticular material having pitch of 75.45 LPI, the result equates to 2,400 DPI/75.45 LPI=31.619 pixels per lenticule. Because this is not an integral number, interlacing at 75.45 LPI will produce pixels, and thus dots—which are simply aggregates of integral numbers of pixels—that do not evenly end on the boarders between lenticules. It is undesirable for a pixel or dot not to completely fit beneath a single lenticule because it can reduce the overall sharpness of the lenticular images.

Thus, a preferred embodiment of the disclosure can employ a “rounding error correction” (REC) technique in which interlacing occurs at, for example, 75 LPI (which corresponds to 2,400 DPI/75 LPI=32 pixels or dots per lenticule). Then the size of the printed pixel is changed to ensure that edges of pixels or pixel aggregates align evenly with the boarders between lenticules. The pixel size may be changed in any convenient manner, e.g., in the software or firmware used on the output device (such as a plate-setter).

The amount of change to the pixel size can be determined, for example, by enlarging the images across the entire width of the lenticular sheet by a factor of (continuing the example above) 75.45/75=100.6%, and also reducing the pixel size by the inverse of this ratio, i.e., from 1/2,400 inch to (1/2,400)×(75/75.45), which reduces the image to the desired result.

Employing some form of REC also accommodates the variation in pitch that all lenticular materials exhibit when they are produced. For example, the 75.45 LPI measurement noted above is a common average value, but commercially available lenticular materials can range from, for example, approximately 75.30 LPI to 75.80 LPI.

Ensuring that the edge of a pixel or dot does not coincide with the interface between image transitions also produces dots that do not inappropriately average pixel tonal values together as illustrated in FIG. 4.

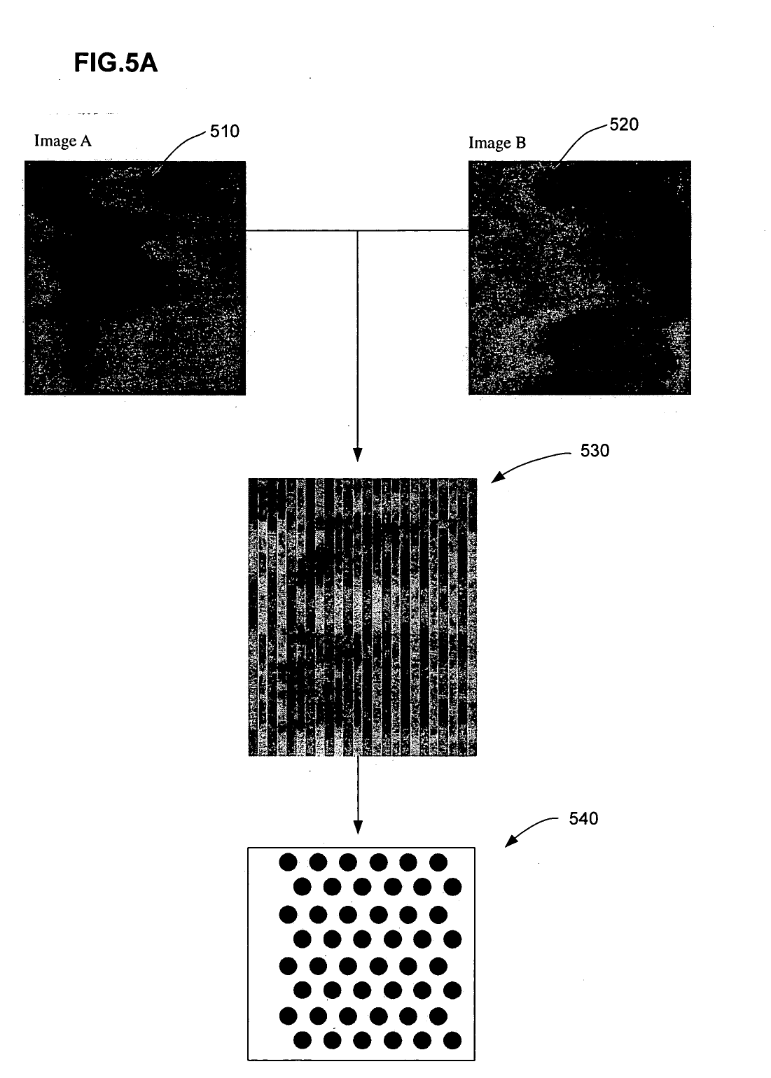

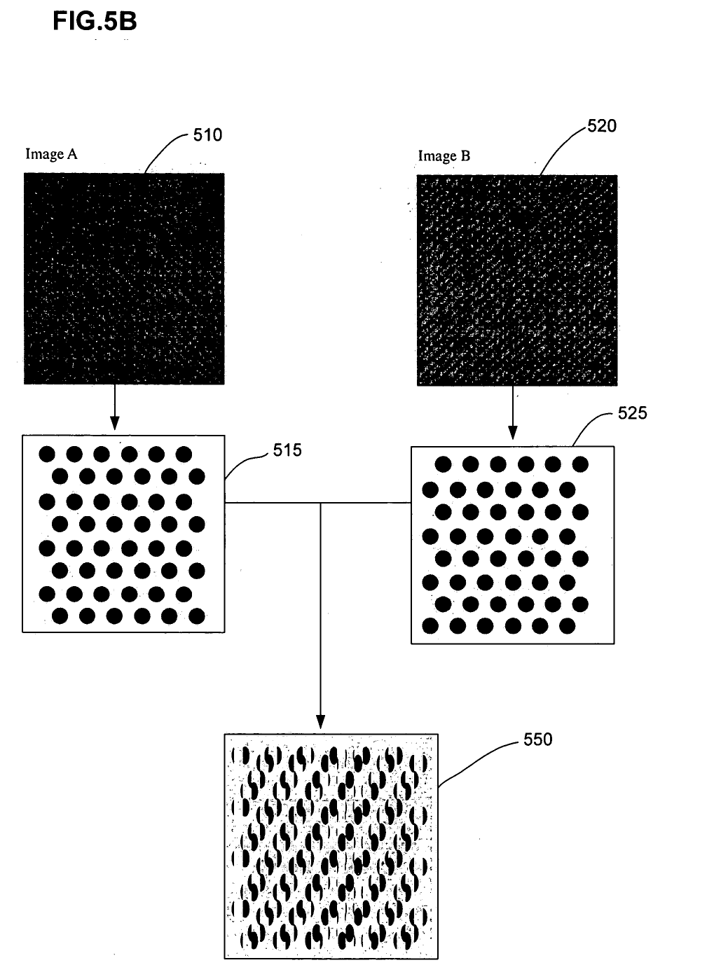

Referring to FIGS. 5A and 5B, FIG. 5A illustrates a conventional interlacing process where for example, a first Image A 510 and a second Image B 520 are interlaced, before rasterizing and screening, to form interlaced image 530. Subsequent rasterizing and screening produces raster and interlaced image or file 540. In the method of the present disclosure shown in FIG. 5B in contrast, a first Image A 510 and a second Image B 520 are separately rasterized and screened to form respective raster screened images or files, Image A′ 515 and Image B′ 525. Next, these raster screened images or files, Image A′ 515 and Image B′ 525, are interlaced to form interlaced lenticular image or file 550.

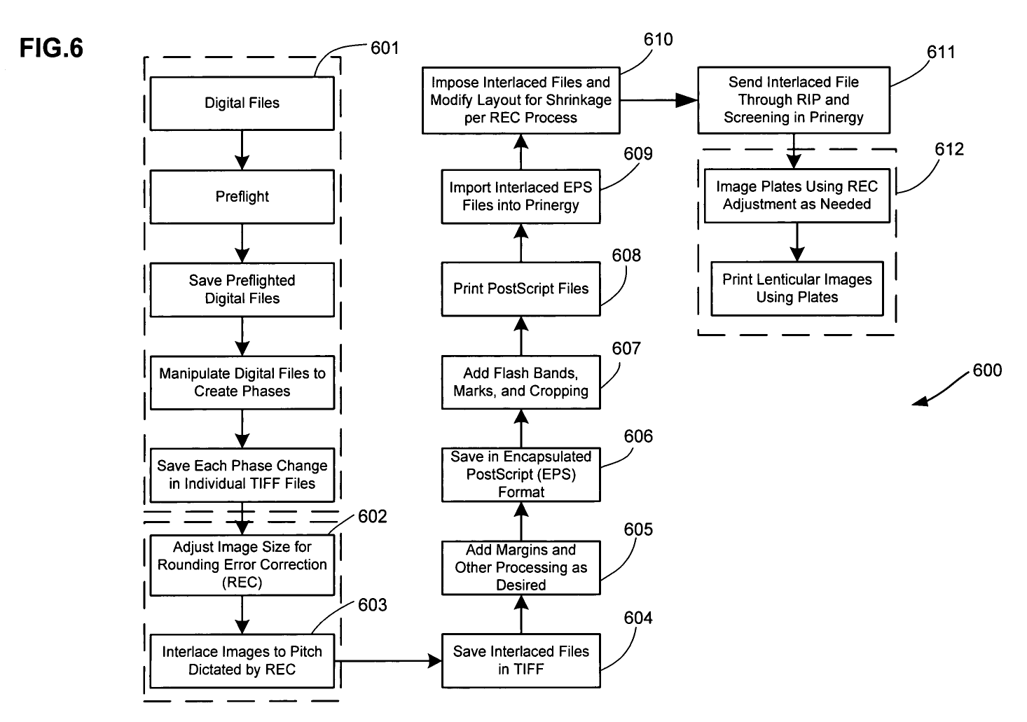

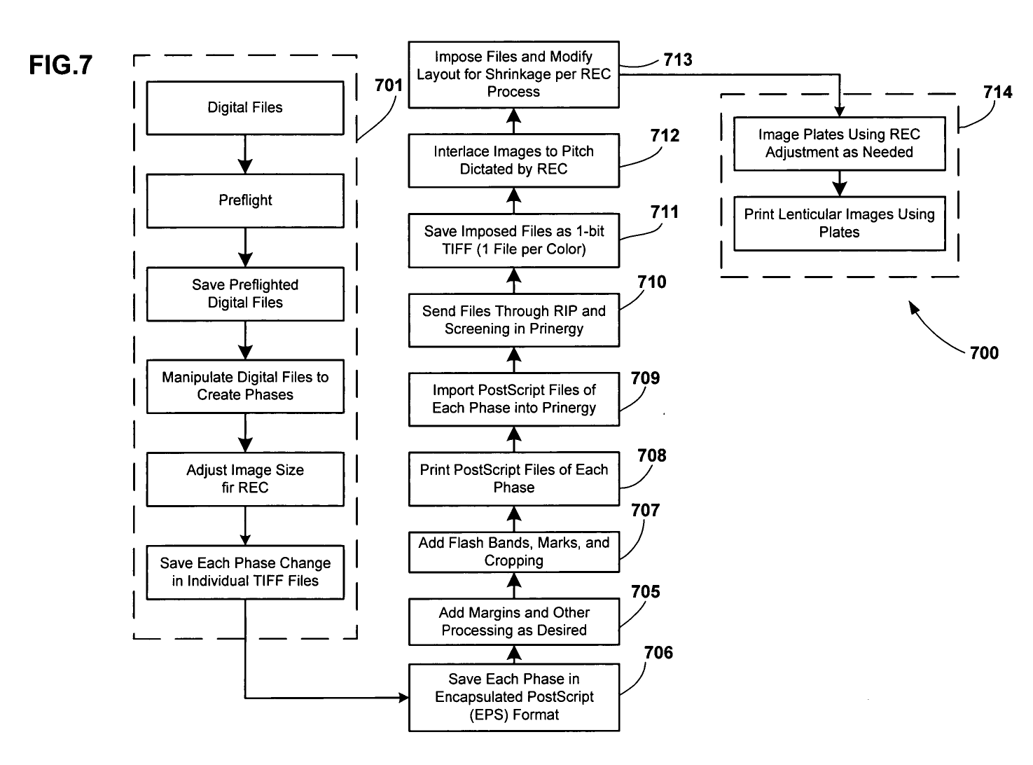

FIGS. 6 and 7 are workflow diagrams illustrating a conventional process (FIG. 6) and a preferred embodiment of the disclosure (FIG. 7). In these figures, “REC” stands for “Rounding Error Correction” and is a process for changing the physical dimension of a pixel, as described above.

As illustrated in FIG. 6, a conventional interlacing process 600 begins with digital files 601 which are preflighted and saved as digital files. The digital files are “phased,” that is manipulated to create the phases, and the each phase change is saved in individual TIFF files. The image size can be adjusted 602 for rounding error correction (REC). Next the images are interlaced to pitch 603 according to the rounding error correction. The interlace files are saved in TIFF 604. Optional processing 605, such as margins or other can be accomplished prior to saving the file in encapsulated PostScript (EPS) Format 606. Flash bands, marks, or cropping can be added or accomplished 607. The PostScript files can then be printed 607. The interlaced EPS files can be imported into Prinergy® WORKFLOW 609. Prinergy® WORKFLOW software is commercially available from Creo, Burnaby, BC, Canada. The files are imposed and the layout modified for shrinkage according to the REC process 610. The imposed files are “ripped” and screened 611 in Prinergy.® Image plates are formed using REC adjustment as needed 612. Finally, the lenticular images are printed using the image plates.

The disclosure provides, as set forth in a preferred workflow of FIG. 7, consistency in the early stages of processing and allows for a change in the image set at the plate production stage so as to exactly fit the particular sheet of lenses available for production. There is no need to resize the input image to match the lens pitch. In embodiments of an interlacing process 700 of the present disclosure the process begins (as in the conventional process) with digital files 701 being preflighted and saved as digital files. The image size can be adjusted for rounding error correction (REC). These digital files are also “phased,” and the each phase change is saved in individual TIFF files.

Each phase is saved as an encapsulated PostScript (EPS) Format 705. Optional processing 706, such as margins or other processing can be accomplished. Flash bands, marks, or cropping can be added or accomplished 707. The PostScript files can then optionally be printed 708. The PostScript files for each phase are then imported into Prinergy® 709. The interlaced files are “ripped” and screened 710 in Prinergy.® The imposed files can then optionally be saved 711 as 1-bit TIFF files, that is, one file per color. Next the images are interlaced 712 to pitch according to the rounding error correction.

The interlaced files are imposed and the layout modified for shrinkage according to the REC process 713. In the final step, image plates are formed 714 using REC adjustment as needed, and then the lenticular images are printed on a printing device using the image plates.

As can be appreciated from the above discussion, the disclosure can be described in general terms as a computer-implemented digital prepress method for interlacing images, comprising in the order of:

providing a set of at least two graphic images to a computer;

raster image processing the digital representations for each image to provide a set of screened color-separated digital files that correspond with each graphic image;

interlacing the screened color-separated digital files of like color for the graphic images to produce one interlaced digital file for each color;

optionally saving the interlaced files as digital files for each color; and outputting the interlaced digital files to a digital output device.

All publications, patents, and patent documents are incorporated by reference herein in their entirety, as though individually incorporated by reference. The disclosure has been described with reference to various specific and preferred embodiments and techniques. However, it should be understood that many variations and modifications can be made while remaining within the spirit and scope of the disclosure.

The claimed invention is:

1. A computer-implemented digital prepress method of interlacing images, comprising the steps in the order of:
providing a set of at least two graphic images to a computer;
raster image processing the digital representations for each image to provide a set of screened color-separated digital files that correspond with each graphic image;
interlacing the screened color-separated digital files of like color for the graphic images to produce one interlaced digital file for each color;
optionally saving the interlaced files as digital files for each color; and
outputting the interlaced digital files to a digital output device.

2. The method of claim 1, further comprising imposing the digital representations for each image to more than one position before raster image processing.

3. The method of claim 1, further comprising imposing the interlaced digital files prior to outputting to a digital output device.

4. The method of claim 1, wherein the interlacing includes rounding error correction.

5. The method of claim 1, wherein the format of the interlaced digital files is a 1-bit TIFF.

6. The method of claim 1, wherein the interlaced digital files are monochromatic bitmaps.

7. The method of claim 1, wherein the interlaced digital files are monochromatic bitmaps in standard tagged image format.

8. The method of claim 1, wherein the digital output device is selected from the group of a direct-to-plate output device, a film recorder, an ink jet printer, a film setter, a digital printing press, a direct-to-screen output device, or combinations thereof.

9. The method of claim 1, wherein the digital output device is a direct-to-plate output device and the plates generated off the direct-to-plate output device are used on a printing press.

10. The method of claim 1, wherein the output device uses a printing method selected from the group of sheet-fed offset, web flexography, web-offset, or combinations thereof.

11. A product comprising a lenticular image printed on a sheet according to the process of claim 1.

12. The product of claim 11, further comprising a lenticular lens sheet mounted to the printed lenticular image sheet.

13. The product of claim 12, wherein the lens of the lenticular lens sheet is selected from a fisheye lens, a spherical lens having a flat top, a triangular lens, an elliptical lens, or combinations thereof.

14. The product of claim 11 wherein the sheet is a lenticular lens.
